(19) United States
(12) Patent Application Publication
(10) Pub. No.: US 2013/0156201 A1
(43) Pub. Date: Jun. 20, 2013

(54) AUDIO CONTROL DEVICE AND AUDIO CONTROL METHOD

(71) Applicant: Kentaro Nakai, Osaka (JP)

(72) Inventor: Kentaro Nakai, Osaka (JP)

(73) Assignee: Panasonic Corporation, Osaka (JP)

(21) Appl. No.: 13/819,772

(22) PCT Filed: Feb. 23, 2012
(86) PCT No.: PCT/JP2012/001247

§ 371 Date: Feb. 28, 2013

(30) Foreign Application Priority Data
Mar. 8, 2011 (JP) 2011-050584

(51) Int. Cl. H04R 5/04

(52) U.S. Cl. CPC H04R 5/04
USPC 381/17

(57) ABSTRACT

An audio control device capable of confirming without the use of sight which sound source stereoscopically located in a virtual space has been selected. This audio control device performs processing related to a sound source stereoscopically located in a virtual space, wherein the device has: a pointer position calculation unit (664) for determining the current position of a pointer, the position being selected in virtual space; and an acoustic pointer generation unit (667) for generating an acoustic pointer that shows the current position of the pointer by differences in the acoustic state with the surroundings.

### TECHNICAL FIELD

The claimed invention relates to an audio control apparatus and audio control method which perform processes related to sound. sources that are disposed three-dimensionally in a virtual space.

### BACKGROUND ART

Services that enable users to exchange short text messages with ease among themselves via a network have seen an increase in recent years. Services that enable users to upload speech to a server in a network and readily share such audio among themselves are also available.

As an arrangement that integrates these services, a service that allows messages coming from a plurality of users to be heard audially instead of being viewed visually is hoped for. This is because being able to audially check short texts (tweets) coming from a plurality of users would enable one to obtain a multitude of information without having to rely on sight.

A technique for handling a multitude of audio information is disclosed in Patent Literature 1, for example. The technique disclosed in Patent Literature 1 disposes, three-dimensionally in a virtual space, a plurality of sound sources, which are allocated to a plurality of audio data, and outputs the audio data. In addition, the technique disclosed in Patent Literature 1 displays a positional relationship diagram of the sound sources on a screen, and indicates, by means of a cursor, which audio is currently selected. By allocating different sound sources to respective output sources using this technique, it may be made easier to differentiate between audio from a plurality of other users.

Furthermore, it becomes possible for the user to perform various operations (e.g., changing the volume) while checking which audio is currently selected.

### CITATION LIST

### Patent Literature

PTL 1

Japanese Patent Application Laid-Open No. 2005-269231

### SUMMARY OF INVENTION

### Technical Problem

However, Patent Literature 1 mentioned above has a problem in that one cannot know which audio is currently selected unless s/he views the screen. To realize a more user friendly service, it is preferable that it be possible to know which audio is currently selected without having to rely on sight.

An object of the claimed invention is to provide an audio control apparatus and audio control method which make it possible to know which of sound sources disposed three-dimensionally in a virtual space is currently selected without having to rely on sight.

### Solution to Problem

An audio control apparatus of the claimed invention includes an audio control apparatus that performs a process with respect to sound sources disposed three-dimensionally in a virtual space, the audio control apparatus including: a pointer position computation section that determines a current position of a pointer, the current position being a selected position in the virtual space; and an acoustic pointer generation section that generates an acoustic pointer, the acoustic pointer indicating the current position of the pointer by means of a difference in acoustic state relative to its surroundings.

An audio control method of the claimed invention includes an audio control method that performs a process with respect to sound sources disposed three-dimensionally in a virtual space, the audio control method including: determining a current position of a pointer, the current position being a selected position in the virtual space; and generating an acoustic pointer, the acoustic pointer indicating the current position of the pointer by means of a difference in acoustic state relative to its surroundings,

### Advantageous Effects of Invention

With the claimed invention, it is possible to know which of sound sources disposed three-dimensionally in a virtual space is currently selected without having to rely on sight.

### BRIEF DESCRIPTION OF DRAWINGS

FIG. 1 is a block diagram showing a configuration example of a terminal apparatus including an audio control apparatus according to an embodiment of the claimed invention;

FIG. 2 is a block diagram showing a configuration example of a control section with respect to the present embodiment;

FIG. 3 is a schematic diagram showing an example of the feel of a sound field of synthesized audio data with respect to the present embodiment;

FIG. 4 is a flow chart showing an operation example of a terminal apparatus with respect to the present embodiment;

FIG. 5 is a flow chart showing an example of a position computation process with respect to the present embodiment; and

FIG. 6 is a schematic diagram showing another example of the feel of a sound field of synthesized audio data with respect to the present embodiment.

### DESCRIPTION OF EMBODIMENTS

An embodiment of the claimed invention is described in detail below with reference to the drawings. This embodiment is an example in which the claimed invention is applied to a terminal apparatus which can be carried outside of one's home, and which is capable of audial communication with other users.

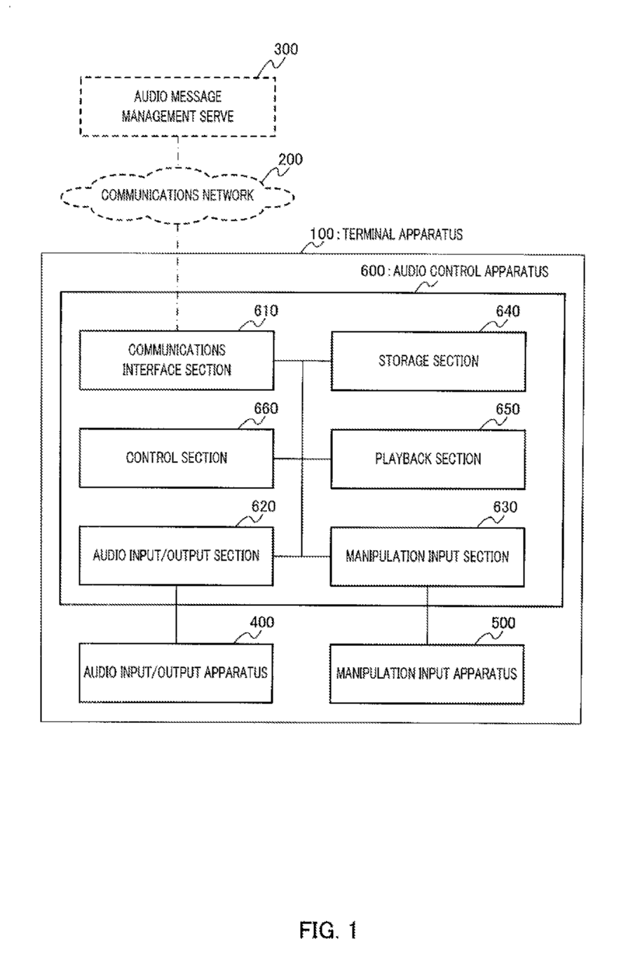

FIG. 1 is a block diagram showing a configuration example of a terminal apparatus including an audio control apparatus according to an embodiment of the claimed invention.

Terminal apparatus 100 shown in FIG. 1 is an apparatus capable of connecting to audio message management server 300 via communications network 200, e.g., the Internet, an intranet, and/or the like. Via audio message management server 300, terminal apparatus 100 exchanges audio message data with other terminal apparatuses (not shown). Audio message data may hereinafter be referred to as “audio message” where appropriate.

Audio message management server 300 is an apparatus that manages audio messages uploaded from terminal apparatuses, and that distributes the audio messages to a plurality of terminal apparatuses upon their being uploaded.

Audio messages are transferred and stored, as files of a predetermined format, e.g., WAV, and/or the like, for example. In particular, when distributing audio messages from audio message management server 300, they may be transferred as streaming data. For the case at hand, it is assumed that uploaded audio messages are appended with metadata including the user name of the uploading user (sender), the upload date and time, and the length of the audio message. The metadata may be transferred and stored as, for example, a file of a predetermined format, e.g., extensible markup language (XML), and/or the like.

Terminal apparatus 100 includes audio input/output apparatus 400, manipulation input apparatus 500, and audio control apparatus 600.

Audio input/output apparatus 400 converts an audio message received from audio control apparatus 600 into audio and outputs it to the user, and converts an audio message received from the user into a signal and outputs it to audio control apparatus 600. For the present embodiment, it is assumed that audio input/output apparatus 400 is a headset including a microphone and headphones.

Audio that audio input/output apparatus 400 inputs includes audio messages from the user intended for uploading, and audio data of manipulation commands for manipulating audio control apparatus 600. Audio data of manipulation commands are hereinafter referred to as “audio commands.” Audio messages are not limited to the user's spoke audio, and may also he audio created through audio synthesis, music, and/or the like.

The term “audio” in the context of the claimed invention refers to sound in general, and is not limited to human vocals, as may be understood from the example citing audio messages. In other words, “audio” refers broadly to sound, such as music, sounds made by insects and animals, man-made sounds (e.g., noise from machines, etc.), sounds from nature (e.g., waterfalls, thunder, etc.), and/or the like.

Manipulation input apparatus 500 detects the user's movements and manipulations (hereinafter collectively referred to as “manipulations”), and outputs to audio control apparatus 600 manipulation information indicating the content of a detected manipulation. For the present embodiment, manipulation input apparatus 500 is assumed to be a 3D (dimension) motion sensor attached to the above-mentioned headset. The 3D motion sensor is capable of determining direction and acceleration. Accordingly, with respect to the present embodiment, manipulation information includes direction and acceleration as information indicating the orientation of the user's head in an actual space. The user's head is hereinafter simply referred to as “head.” Furthermore, with respect to the present embodiment, the orientation of the user's head in an actual space is defined as the orientation of the front of the face.

It is assumed that audio input/output apparatus 400 and manipulation input apparatus 500 are each connected to audio control apparatus 600 via, for example, a physical cable, and/or wireless communications, such as Bluetooth (registered trademark), and/or the like.

Audio control apparatus 600 disposes, as sound sources within a virtual space, audio messages received from audio message management server 300, and outputs them to audio input/output apparatus 400.

Specifically, audio control apparatus 600 disposes, three-dimensionally and as sound sources in a virtual space, audio messages by other users sent from audio message management ser 300. Audio messages by other users sent from audio message management server 300 are hereinafter referred to as “incoming audio messages.” Audio control apparatus 600 converts them into audio data whereby audio messages would be heard as if coming the sound sources disposed in the virtual space, and outputs them to audio input/output apparatus 400. In other words, audio control apparatus 600 disposes a plurality of incoming audio messages in the virtual space in such a manner as to enable them to be distinguished with ease, and supplies them to the user.

In addition, audio control apparatus 600 sends to audio message management server 300 an audio message by the user inputted from audio input/output apparatus 400. Audio messages by the user inputted from audio input/output apparatus 400 are hereinafter referred to as “outgoing audio messages.” In other words, audio control apparatus 600 uploads outgoing audio messages to audio message management server 300.

Audio control apparatus 600 determines the current position of a pointer, which is a selected position in the virtual space, and indicates that position using an acoustic pointer. For the present embodiment, it is assumed that the pointer is a manipulation pointer that indicates the position currently selected as a target of a manipulation. The acoustic. pointer is a pointer that indicates, with respect to the virtual space, the current position of the pointer (i.e., the manipulation pointer in the present embodiment) in terms of differences in the acoustic state of the audio message relative to the surroundings.

The acoustic pointer may be embodied as, for example, the difference between the audio message of the sound source corresponding to the current position of the manipulation pointer and another audio message. This difference may include, for example, the currently selected audio message being, due to differences in sound quality, volume, and/or the like, clearer than another audio message that is not selected. Thus, through changes in the sound quality, volume, and/or the like, of each audio message, the user is able to know which sound source is currently selected.

Furthermore, the acoustic pointer may be embodied as, for example, a predetermined sound, e.g., a beep, and/or the like, outputted from the current position of the manipulation pointer. In this case, the user would be able to recognize the position from which the predetermined sound is heard to be the position of the manipulation pointer, and to thus know which sound source is currently selected.

For the present embodiment, it is assumed. that the acoustic pointer is embodied as a predetermined synthesized sound outputted periodically from the current position of the manipulation pointer. This synthesized sound is hereinafter referred to as a “pointer sound.” Since the manipulation pointer and the acoustic pointer have mutually corresponding positions, they may be referred to collectively as “pointer” where appropriate.

Audio control apparatus 600 accepts from the user via manipulation input apparatus 500 movement manipulations with respect to the pointer and determination manipulations with respect to the sound source currently selected by the pointer. Audio control apparatus 600 performs various processes specifying the sound source for which a determination manipulation has been performed. Specifically, a determination manipulation is a manipulation that causes a transition from a state where the user is listening to an incoming audio message to a state where a manipulation specifying an incoming audio message is performed. In so doing, as mentioned above, audio control apparatus 600 accepts user input of manipulation commands through audio commands, and performs processes corresponding to the inputted manipulation commands.

It is assumed that a determination manipulation with respect to the present embodiment is carried out through a nodding gesture of the head. Furthermore, it is assumed that processes specifiable through manipulation commands include, for example, trick plays such as starting playback of incoming audio data, stopping playback, rewinding, and/or the like.

As shown in FIG. 1, audio control apparatus 600 includes communications interface section 610, audio input/output Section 620, manipulation input section 630, storage section 640, control section 660, and playback section 650.

Communications interface section 610 connects to communications network 200, and, via communications network 200, to audio message management server 300 and the world wide web (WWW) to send/receive data. Communications interface section 610 may be, for example, a communications interface for a wired local area network (LAN) or a wireless LAN.

Audio input/output section 620 is a communications interface for communicably connecting to audio input/output apparatus 400.

Manipulation input section 630 is a communications interface for communicably connecting to manipulation input apparatus 500.

Storage section 640 is a storage region used by the various sections of audio control apparatus 600, and stores incoming audio messages, for example. Storage section 640 may be, for example, a non-volatile storage device that retains its stored contents even when power supply is suspended, e.g., a memory card, and/or the like.

Control section 660 receives, via communications interface section 610, audio messages distributed from audio message management server 300. Control section 660 disposes the incoming audio message three-dimensionally in a virtual space. Control section 660 receives manipulation information from manipulation input apparatus 500 via manipulation input section 630, and accepts movement manipulations and determination manipulations of the above-mentioned manipulation pointer.

In so doing, control section 660 generates the above-mentioned acoustic pointer. Control section 660 generates, and outputs to playback section 650, audio data that is obtained by synthesizing a three-dimensionally disposed incoming audio message and the acoustic pointer disposed at the position of the manipulation pointer. Such synthesized audio data is hereinafter referred to as “three-dimensional audio data.”

Control section 660 receives outgoing audio messages from audio input/output apparatus 400 via audio input/output section 620, and uploads them to audio message management server 300 via communications interface section 610. Control section 660 also performs determination manipulations on a selected target. As audio commands are received from audio input/output apparatus 400 via audio input/output section 620, control section 660 performs various processes on the above-mentioned incoming audio data and/or the like.

Playback section 650 decodes the three-dimensional audio data received from control section 660, and outputs it to audio input/output apparatus 400 via audio input/output section 620.

Audio control apparatus 600 may be a computer including a central processing unit (CPU), a storage medium (e.g., random access memory (RAM)), and/or the like, for example. In this case, audio control apparatus 600 operates by having stored control programs executed by the CPU.

This terminal apparatus 100 indicates the current position of the manipulation pointer by means of the acoustic pointer. Thus, terminal apparatus 100 enables the user to perform manipulations while knowing which of the sound sources disposed three-dimensionally in a virtual space is currently selected without having to rely on sight. In other words, even if terminal apparatus 100 is equipped with a screen display apparatus, the user is able to perform manipulations while knowing which sound source is currently selected without having to use a graphical user interface (GUI). In other words, by using terminal apparatus 100 according to the present embodiment, the user is able to make selections by relying on sound sources, which are subject to manipulations, without having to look at the screen.

Example details of control section 660 will now be described.

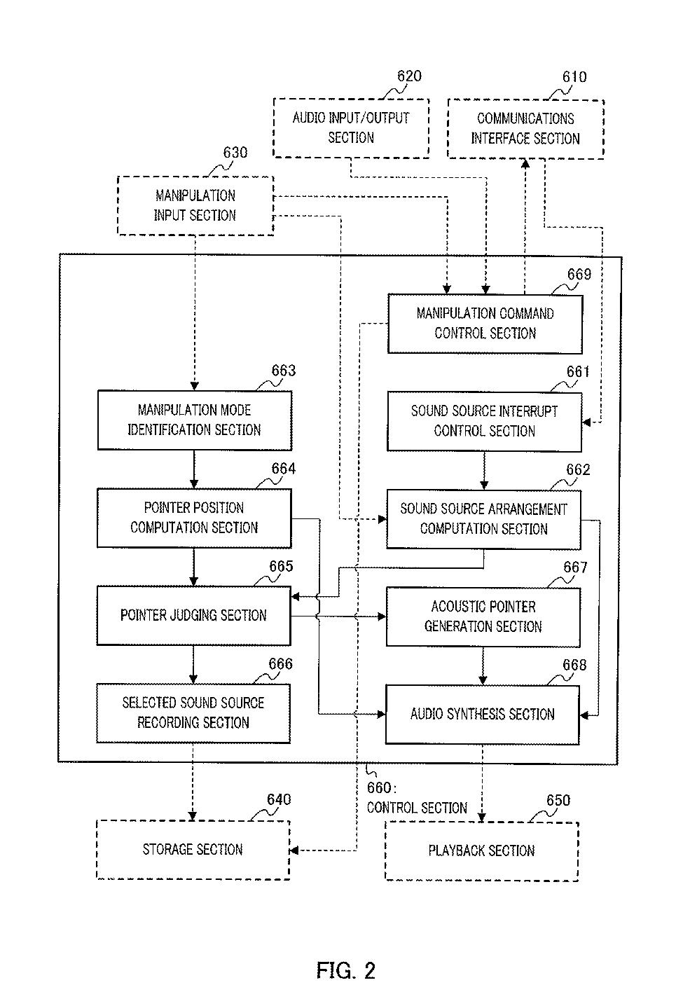

FIG. 2 is a block diagram showing a configuration example of control section 660.

As shown in FIG. 2, control section 660 includes sound source interrupt control section 661, sound source arrangement computation section 662, manipulation mode identification section 663, pointer position computation section 664, pointer judging section 665, selected sound source recording section 666, acoustic pointer generation section 667, audio synthesis section 668, and manipulation command control section 669.

Each time an audio message is received via communications interface section 610, sound source interrupt control section 661 outputs the incoming audio message to sound source arrangement computation section 662 along with an interrupt notification.

Each time an interrupt notification is received, sound source arrangement computation section 662 disposes the incoming audio message in a virtual space. Specifically, sound source arrangement computation section 662 disposes incoming audio data at respectively different positions corresponding to the senders of the incoming audio data.

By way of example, a case will now be considered where, in a state where an incoming audio message from a first sender is already disposed, an interrupt notification for an incoming audio message from a second sender is inputted to sound source arrangement computation section 662. In this case, sound source arrangement computation section 662 disposes the incoming audio message from the second sender at a position that differs from that of the first sender. By way of example, sound sources are equidistantly disposed along a circle that is centered around the user's position and that is in a plane horizontal relative to the head. Sound source arrangement computation section 662 outputs to pointer judging section 665 and audio synthesis section 668 the current positions of the sound sources in the virtual space along with the incoming audio messages and the identification information of each of the incoming audio messages.

When the mode of operation is manipulation mode, manipulation mode identification section 663 outputs manipulation information received via manipulation input section 630 to pointer position computation section 664. Manipulation mode, in this case, is a mode for performing manipulations using the manipulation pointer. Manipulation mode identification section 663 with respect to the present embodiment transitions to a manipulation mode process with a head nodding gesture as a trigger.

First, based on manipulation information, pointer position computation section 664 determines the initial state of the orientation of the head in the actual space (e.g., a forward facing state), and fixes the orientation of the virtual space to the orientation of the head in the initial state. Then, each time manipulation information is inputted, pointer position computation section 664 computes the position of the manipulation pointer in the virtual space based on a comparison of the orientation of the head relative to the initial state. Pointer position computation section 664 outputs to pointer judging section 665 the current position of the manipulation pointer in the virtual space.

Pointer position computation section 664 with respect to the present embodiment obtains as the current position of the manipulation pointer a position that is at a predetermined distance from the user in the direction the user's face is facing. Accordingly, the position of the manipulation pointer in the virtual space changes by following changes in the orientation of the user's head, thus always being located straight ahead of the user's face. This is comparable to turning one's face towards an object of interest.

Pointer position computation section 664 obtains, as the orientation of the headset, the orientation of the head in the real world as determined based on the manipulation information. Pointer position computation section 664 generates headset tilt information based on the orientation of the headset, and outputs it to pointer judging section 665 and audio synthesis section 668. The headset tilt information mentioned above is information, indicating the difference between a headset coordinate system, which is based on the position and orientation of the headset, and a coordinate system in the virtual space.

Pointer judging section 665 judges whether or not the inputted current position of the manipulation pointer corresponds to the inputted current position of any of the sound sources. In other words, pointer judging section 665 judges which sound source the user has his/her face turned to.

In this context, a sound source with a corresponding position is understood to mean a sound source that is within a predetermined range centered around the current position of the manipulation pointer. Furthermore, the term current position is meant to include not only the current position of the manipulation pointer but also the immediately preceding position. A sound source with a corresponding position may hereinafter be referred to as “the currently selected sound source” where appropriate. Furthermore, an incoming audio message to which the currently selected sound source is allocated is referred to as “the currently selected incoming audio message.”

Whether or not its position was within a predetermined range centered around the position of the manipulation pointer at the time immediately prior may be judged in the following manner, for example. First, for each sound source, pointer judging section 665 counts the elapsed time from when it came to be within the predetermined range centered around the position of the manipulation pointer. Then, for each sound source for which counting has begun, pointer judging section 665 successively judges whether or not the count value thereof is at or below a predetermined threshold. While the count value is at or below the predetermined threshold, pointer judging section 665 judges the sound source in question to be a sound source whose position is within the above-mentioned predetermined range. Thus, once an incoming audio message is selected, pointer judging section 665 maintains that selected state for a given period, thus realizing a lock-on function for selected targets.

Pointer judging section 665 outputs to selected sound source recording section 666 the identification information of the currently selected sound source along with the currently selected incoming audio message. Pointer judging section 665 outputs the current position of the manipulation pointer to acoustic pointer generation section 667.

Selected sound source recording section 666 maps the received incoming audio message to the received identification information and temporarily records them in storage section 640.

Based on the received current position of the manipulation pointer, acoustic pointer generation section 667 generates an acoustic pointer. Specifically, acoustic pointer generation section 667 generates audio data in such a manner that pointer sound output would be outputted from the current position of the manipulation pointer in the virtual space, and outputs the generated audio data to audio synthesis section 668.

Audio synthesis section 668 generates synthesized audio data by superimposing the received pointer sound audio data onto the received incoming audio message, and outputs it to playback section 650. In so doing, audio synthesis section 668 localizes the sound image of each sound source by converting, based on the received headset tilt information, coordinates of the virtual space into coordinates of the headset coordinate system, which serves as a reference. Audio synthesis section 668 thus generates such synthesized audio data that each sound source and the acoustic pointer would be heard from their respective set positions.

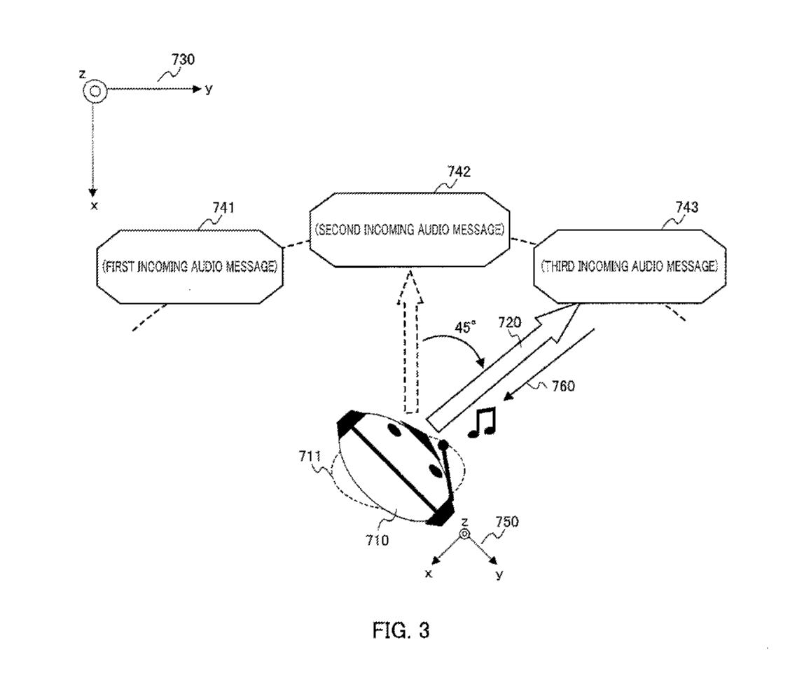

FIG. 3 is a schematic diagram showing an example of the feel of a sound field which synthesized audio data gives to the user.

As shown in FIG. 3, it is assumed that the position of manipulation pointer 720 is determined based on the orientation of the head of user 710 in the initial state, and that the orientation of coordinate system 730 of the virtual space is fixed to the actual space. For the case at hand, coordinate system 730 of the virtual space takes the squarely rearward direction, with respect to the initial position of user 710, to be the X-axis direction, the right direction to be the Y-axis direction, and the upward direction to be the −axis direction.

It is assumed that sound sources 741 through 743 are disposed equidistantly along a circle at 45° to the left from user 710, squarely forward, and 45° to the right, respectively, for example. In FIG. 3, it is assumed that sound sources 741 through 743 correspond to the first to third incoming audio messages, respectively, and are thus disposed.

In this case, headset coordinate system 750 is considered as a coordinate system based on the positions of the left and right headphones of the headset. In other words, headset coordinate system 750 is a coordinate system that is fixed to the position and orientation of the head of user 710. Accordingly, the orientation of headset coordinate system 750 follows changes in the orientation of user 710 in the actual space. Thus, user 710 experiences a sound field feel as if the orientation of his/her head has also changed in the virtual space just like the orientation of his/her head in the actual space has changed. In the example in FIG. 3, user 710 rotates his/her head 45° to the right from initial position 711. Thus, sound sources 741 through 743 relatively rotate 45° to the left about user 710.

Acoustic pointer 760 is always disposed squarely forward of the user's face. Thus, user 710 experiences a sound field feel as if acoustic pointer 760 is heard from the direction of the audio towards which his/her face is turned (i.e., the third incoming audio message in the case of FIG. 3). In other words, user 710 is given feedback as to which sound source is selected by acoustic pointer 760.

When the manipulation information received from manipulation input section 630 is a determination manipulation for the currently selected sound source, manipulation command control section 669 in FIG. 2 awaits a manipulation command. When the audio data received from audio input/output section 620 is an audio command, manipulation command control section 669 obtains the corresponding manipulation command. Manipulation command control section 669 issues the obtained manipulation command, and instructs to other various sections a process corresponding to that manipulation command.

When the received audio data is an outgoing audio message, manipulation command control section 669 sends the outgoing audio message to audio message management server 300 via communications interface section 610.

By virtue of such a configuration, control section 660 is able to dispose incoming audio messages three-dimensionally in a virtual space, and to accept manipulations for sound sources while letting the user know, by means of the acoustic pointer, which sound source is currently selected.

Operations of terminal apparatus 100 will now be described.

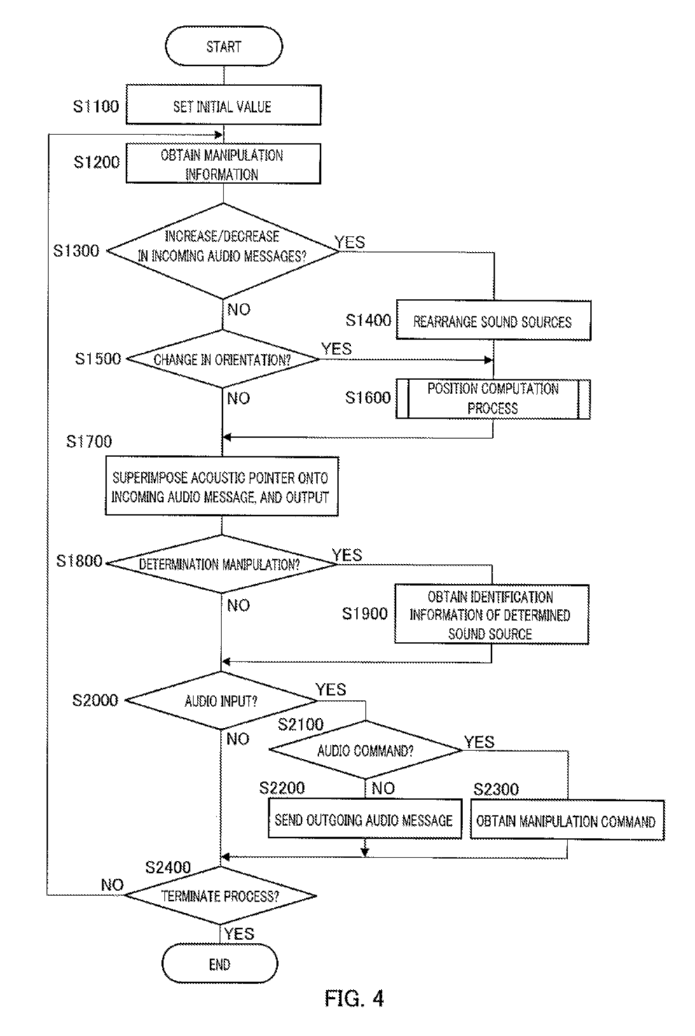

FIG. 4 is a flow chart showing an operation example of terminal apparatus 100. A description is provided below with a focus on a manipulation mode process, which is performed when it is in manipulation mode.

First, in step S1100, pointer position computation section 664 sets (records), in storage section 640 as an initial value, the azimuth of the orientation of the head as indicated by manipulation information. This initial value is a value that serves as a reference for the correspondence relationship among the coordinate system of the actual space, the coordinate system of the virtual space, and the headset coordinate system, and is a value that is used as an initial value in detecting the user's movement.

Then, in step S1200, manipulation input section 630 begins to successively obtain manipulation information from manipulation input apparatus 500.

Then, in step S1300, sound source interrupt control section 661 receives an audio message via communications interface section 610, and determines whether or not there is an increase/decrease in the audio messages (incoming audio messages) to be played at the terminal. In other words, sound source interrupt control section 661 determines the presence of any new audio messages to be played, and whether or not there are any audio messages whose playing has been completed. If there is an increase/decrease in incoming audio messages (S1300: YES), sound source interrupt control section 661 proceeds to step S1400. On the other hand, if there is no increase/decrease in incoming audio messages (S1300: NO), sound source interrupt control section 661 proceeds to step S1500.

In step S1400, sound source arrangement computation section 662 rearranges sound sources in the virtual space, and proceeds to step S1600. In so doing, it is preferable that sound source arrangement computation 662 determine the sex of other users based on the sound quality of the incoming audio messages, and that it make an arrangement that lends to easier differentiation among the audio, such as disposing audio of other users of the same sex far apart from one another, and so forth.

On the other hand, in step S1500, based on a comparison between the most recent manipulation information and the immediately preceding manipulation information, pointer position computation section 664 determines whether or not there has been any change in the orientation of the head. If there has been a change in the orientation. of the head (S1500: YES), pointer position computation section 664 proceeds to step S1600. If there has been no change in the orientation of the head (S1500: NO), pointer position computation section 664 proceeds to step S1700.

In step S1600, terminal apparatus 100 executes a position computation process, whereby the positions of the sound sources and the pointer position are computed, and proceeds to step S1700.

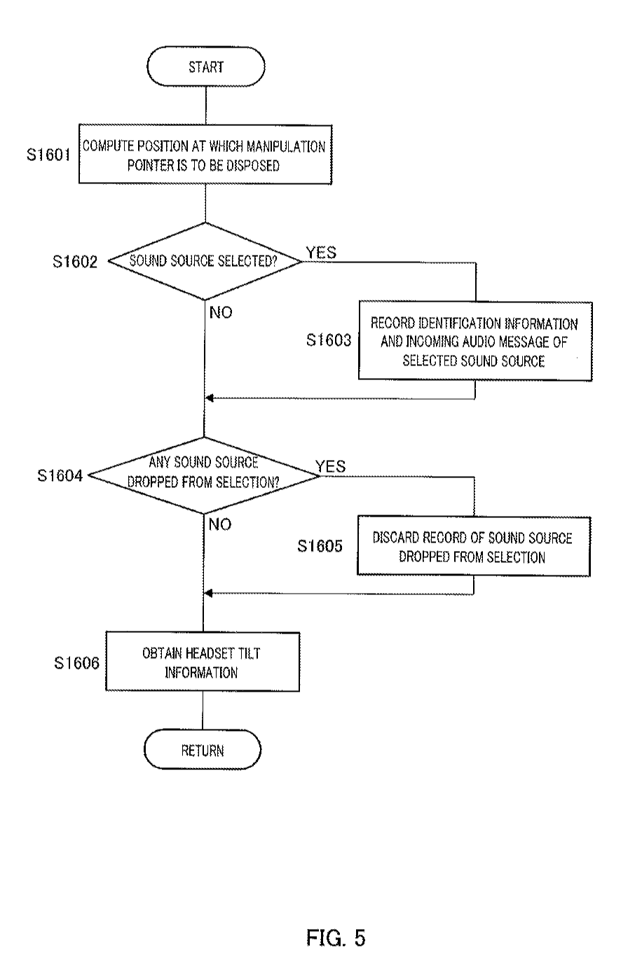

FIG. 5 is a flow chart showing an example of a position computation process.

First, in step S1601, pointer position computation section 664 computes the position at which the manipulation pointer is to be disposed based on manipulation information.

Then, in step S1602, based on the position of the manipulation pointer and the arrangement of the sound sources, pointer judging section 665 determines whether or not there is a sound source that is currently selected. If there is a sound source that is currently selected (S1602: YES), pointer judging section 665 proceeds to step S1603. On the other hand, if there is no sound source that is currently selected (S1602: NO), pointer judging section 665 proceeds to step S1604.

In step S1603, selected sound source recording section 666 records, in storage section 640, the identification information and incoming audio message (including metadata) of the currently selected sound source, and proceeds to step S1604.

When a sound source is selected, it is preferable that acoustic pointer generation section 667 alter the audio characteristics of the acoustic pointer. In addition, it is preferable that this audio characteristic alteration be distinguishable from the audio of a case where the sound source is not selected.

In step S1604, pointer judging section 665 determines, with respect to the sound sources that were selected immediately prior, whether or not there is a sound source has been dropped from the selection. If there is a sound source that has been dropped from the selection (S1604: YES), pointer judging section 665 proceeds to step S1606. On the other hand, if no sound source has been dropped from the selection (S1604: NO), pointer judging section 665 proceeds to step S1606.

In step S1605, selected sound source recording section 666 discards records of the identification information and incoming audio message of the sound source that has been dropped from the selection, and proceeds to step S1606.

If some sound source is dropped from the selection, it is preferable that acoustic pointer generation section 667 notify the user of as much by altering the audio characteristics of the acoustic pointer, for example. Furthermore, it is preferable that this audio characteristic alteration be distinguishable from the audio characteristic alteration that is made when a sound source is selected.

In step S1606, pointer position computation section 664 obtains head tilt information from manipulation information, and returns to the process in FIG. 4.

In computing the position at which the manipulation pointer is to be disposed and the headset tilt information, pointer position computation section 664 may integrate the acceleration to compute a position relative to the initial position of the head and use this relative position. However, since a relative position computed thus might contain a lot of errors, it is preferable that the ensuing pointer judging section 665 be given a wide matching margin between the manipulation pointer position and the sound source position.

In step S1700 in FIG. 4, audio synthesis section 668 outputs synthesized audio data, which is obtained by superimposing the acoustic pointer generated at acoustic pointer generation section 667 onto the incoming audio message.

Then, in step S1800, based on manipulation information, manipulation command control section 669 determines whether or not a determination manipulation has been performed with respect to the currently selected sound source. If, for example, there exists a sound source for which identification information is recorded in storage section 640, manipulation command control section 669 determines that this sound source is the currently selected sound source. If a determination manipulation is performed with respect to the currently selected sound source (S1800: YES), manipulation command control section 669 proceeds to step S1900. On the other hand, if no determination manipulation is performed with respect to the currently selected sound source (S1800: NO), manipulation command control section 669 proceeds to step S2000.

In step S1900, manipulation command control section 669 obtains the identification information of the sound source that was the target of the determination manipulation. A sound source targeted by a determination manipulation will hereinafter be referred to as a “determined sound source.”

If the inputting of a manipulation command is to be taken as a determination manipulation, the processes of steps S1800 and S1900 are unnecessary.

Then, in step S2000, manipulation command control section 669 determines whether or not there has been any audio input by the user. If there has been any audio input (S2000: YES), manipulation command control section 669 proceeds to step S2100. On the other hand, if there has not been any audio input (S2000: NO), manipulation command control section 669 proceeds to step S2400 which will be discussed hereinafter.

In step S2100, manipulation command control section 669 determines whether or not the audio input is an audio command. This determination is carried out, for example, by performing an audio recognition process on the audio data using an audio recognition engine, and searching for the recognition result in a list of pre-registered audio commands. The list of audio commands may be registered in audio control apparatus 600 manually by the user. Alternatively, the list of audio commands may be obtained by audio control apparatus 600 from an external information server, and/or the like, via communications network 200.

By virtue of the previously-mentioned lock-on function, the user no longer needs to issue an audio command in a hurry without moving after selecting an incoming audio message. In other words, the user is allowed to issue audio commands with some leeway in time. Furthermore, even if the sound sources were to be rearranged. immediately after a given incoming audio message has been selected, that selected state would be maintained. Accordingly, even if such a rearrangement of the sound sources were to occur, the user would not have to re-select the incoming audio message.

If the audio input is not an audio command (S2100: NO), manipulation command control section 669 proceeds to step S2200. On the other hand, if the audio input is an audio command (S2100: YES), manipulation command control section 669 proceeds to step S2300.

In step S2200, manipulation command control section 669 sends the audio input to audio message management server 300 as an outgoing audio message, and proceeds to step S2400.

In step S2300, manipulation command control section 669 obtains a manipulation command indicated by the audio command, instructs a process corresponding to that manipulation command to the other various sections, and proceeds to step S2400. By way of example, if the audio inputted by the user is “stop,” manipulation command control section 669 stops the playing of the currently selected audio message.

Then, in step S2400, manipulation mode identification section 663 determines whether or not termination of the manipulation mode process has been instructed through a gestured mode change manipulation, and/or the like. If termination of the manipulation mode process has not been instructed (S2400: NO), manipulation mode identification section 663 returns to step S1200 and obtains the next manipulation information. On the other hand, if termination of the manipulation mode process has been instructed (S2400: YES), manipulation mode identification section 663 terminates the manipulation mode process.

Through such an operation, terminal apparatus 100 is able to dispose sound sources in the virtual space, to accept movement manipulations and determination manipulations for the manipulation pointer based on the orientation of the head, and to accept specifications of processes regarding the sound sources through audio commands. In so doing, terminal apparatus 100 is able to indicate the current position of the manipulation pointer by means of the acoustic pointer.

Thus, an audio control apparatus according to the present embodiment presents the current position of a manipulation pointer to the user by means of an acoustic pointer, which is indicated by a difference in acoustic state relative to its surroundings. Thus, an audio control apparatus according to the present embodiment is able to let the user perform manipulations while knowing which of the sound sources disposed three-dimensionally in a virtual space is currently selected without having to rely on sight.

An audio control apparatus may perform the inputting of manipulation commands through a method other than audio command input, e.g., through bodily gestures by the user.

When using gestures, an audio control apparatus may detect the user's gesture based on acceleration information, azimuth information, and/or the like, outputted from a 3D motion sensor worn on the user's fingers and/or arms, for example. The audio control apparatus may determine whether the detected gesture corresponds to any of the gestures pre-registered in connection with manipulation commands.

In this case, the 3D motion sensor may be built into an accessory, such as a ring, a watch, etc. Furthermore, in this case, the manipulation mode identification section may transition to the manipulation mode process with a certain gesture as a trigger.

For gesture detection, manipulation information may be recorded over a given period to obtain a pattern of changes in acceleration and/or azimuth, for example. The end of a given gesture may be detected when, for example, the change in acceleration and/or azimuth is extreme, or when a change in acceleration and/or azimuth has not occurred for a predetermined period or longer.

An audio control apparatus may accept from the user a switch between a first manipulation mode, where the inputting of manipulation commands is performed through audio commands, and a second manipulation mode, where the inputting of manipulation commands is performed through gesture.

In this case, the manipulation mode identification section may determine which operation mode has been selected based on, for example, whether a head nodding gesture or a hand waving gesture has been performed. The manipulation mode identification section may also accept from the user and store in advance a method of specifying manipulation modes.

The acoustic pointer generation section may lower the volume of the pointer sound, or stop outputting it altogether (mute), while there exists a sound source that is currently selected. On the contrary, the acoustic pointer generation section may increase the volume of the pointer sound while there exists a sound source that is currently selected.

The acoustic pointer generation section may also employ a pointer sound that is outputted only when a new sound source has been selected, instead of a pointer sound that is outputted periodically. Particularly, in the case, the acoustic pointer generation section may have the pointer sound be audio that reads information in the metadata aloud, as in “captured!,” and/or the like. Thus, it would be fed back to user 710 specifically which sound source is currently selected by acoustic pointer 760, making it easier for the user to time the issuing of commands.

The acoustic pointer may also be embodied as a difference between the audio of the sound source corresponding to the current position of the manipulation pointer and some other audio (a change in audio characteristics) as mentioned above.

In this case, the acoustic pointer generation section performs a masking process on incoming audio messages other than the currently selected incoming audio message with a low-pass filter, and/or the like, and cuts the high-frequency components thereof, for example. As a result, the non-selected incoming audio messages are heard by the user in a somewhat muffled manner, and just the currently selected incoming audio message is heard clearly with good sound quality.

Alternatively, the acoustic pointer generation section may relatively increase the volume of the currently selected incoming audio message, or differentiate the currently selected incoming audio message from the non-selected incoming audio messages by way of pitch, playback speed, and/or the like. As a result, the audio control apparatus would make the audio of the sound source located at the position of the manipulation pointer clearer than the audio of the other sound sources, thus setting it apart from the rest to have it heard relatively better.

Cases where the acoustic pointer is thus embodied as a change in the audio characteristics of incoming audio messages also allow user 710 to know specifically which sound source is currently selected with greater ease.

The acoustic pointer may also be embodied as a combination of pointer sound output and a change in the audio characteristics of incoming audio messages.

The acoustic pointer generation section may also accept from the user a selection regarding acoustic pointer type. Furthermore, the acoustic pointer generation section may prepare a plurality of types of pointer sounds or audio characteristic changes, and accept from the user, or randomly select, the type to be used.

It is preferable that the sound source arrangement computation section not assign a plurality of audio messages to one sound source, and that it instead set a plurality of sound sources sufficiently apart so as to allow them to be distinguished, but this is by no means limiting. If a plurality of audio messages are assigned to a single sound source, or if a plurality of sound sources are disposed at the same position or at proximate positions, it is preferable that the acoustic pointer generation section notify the user of as much by audio.

In this case, the pointer judging section may further accept a specification as to which data, from among the plurality of audio data the user wishes to select. The pointer judging section may carry out this accepting of a specification, or a selection target switching manipulation, using pre-registered audio commands or gestures, for example. By way of example, it may be preferable to have a selection target switching manipulation mapped to a quick head shaking gesture resembling a motion for rejecting the current selection target.

The acoustic pointer generation section may also accept simultaneous determination manipulations for a plurality of audio messages.

The audio control apparatus may accept selection manipulations, determination manipulations, and manipulation commands for sound sources not only during playback of incoming audio messages, but also after playback thereof has finished. In this case, the sound source interrupt control section retains the arrangement of the sound sources for a given period even after incoming audio messages have ceased coming in. In addition, in this case, since playback of the incoming audio messages is already finished, it is preferable that the acoustic pointer generation section generate an acoustic pointer that is embodied as predetermined audio, e.g., a pointer sound, and/or the like.

The arrangement of the sound sources and the position of the acoustic pointer are by no means limited to the example above.

The sound source arrangement computation section may also dispose sound sources at positions other than in a plane horizontal to the head, for example. By way of example, the sound source arrangement computation section may dispose a plurality of sound sources at different positions along the vertical direction (i.e., the Z-axis direction in coordinate system 730 of the virtual space in FIG. 3).

Sound source arrangement computation section may also arrange the virtual space in tiers in the vertical direction (i.e., the Z-axis direction in coordinate system 730 of the virtual space in FIG. 3), and dispose one sound source or a plurality of sound sources per tier. In this case, the pointer position computation section is to accept selection manipulations for the tiers, and selection manipulations for the sound source(s) in each of the tiers. As with the above-described selection manipulation for sound sources, the selection manipulation for the tiers may be realized through the orientation of the head in the vertical direction, through gesture, through audio commands, and/or the like.

The sound source arrangement computation section may also determine the arrangement of the sound sources to be allocated respectively to incoming audio messages in accordance with the actual positions of other users. In this case, the sound source arrangement computation section computes the positions of the other users relative to the user based on a global positioning system (GPS) signal, for example, and disposes the respective sound sources in directions corresponding to those relative positions. In so doing, the sound source arrangement computation section may dispose the corresponding sound sources at distances reflecting the distances of the other users from the user.

The acoustic pointer generation section may also dispose the acoustic pointer at a position that is distinguished from those of the sound sources in the vertical direction within a range that would allow recognition as to which sound source it corresponds to. If the sound sources are disposed in a plane other than a horizontal plane, the acoustic pointer generation section may similarly dispose the acoustic pointer at a position distinguished from those of the sound sources in a direction perpendicular thereto.

Although not described in connection with the present embodiment, the audio control apparatus or the terminal apparatus may include an image output section, and visually display the sound source arrangement and the manipulation pointer. In this case, the user would be able to perform manipulations with respect to sound sources while also referencing image information when he/she is able to pay attention to the screen.

The pointer position computation section may also set the position of the acoustic pointer based on output information of a 3D motion sensor of the headset and output information of a 3D motion sensor of an apparatus worn on the torso of the user (e.g., the terminal apparatus itself). In this case, the pointer position computation section would be able to compute the orientation of the head based on the difference between the orientation of the apparatus worn on the torso and the orientation of the headset, and to thus improve the accuracy with which the acoustic pointer follows the orientation of the head.

The pointer position computation section may also move the manipulation pointer in accordance with the orientation of the user's body. In this case, the pointer position computation section may use, as manipulation information, output information of a 3D motion sensor attached to, for example, the user's torso, or to something whose orientation coincides with the orientation of the user's body, e.g., the user's wheelchair, the user's scat in a vehicle, and/or the like.

The audio control apparatus need not necessarily accept pointer movement manipulations from the user. In this case, for example, the pointer position computation section may move the pointer position according to some pattern or at random. The user may then perform a sound source selection manipulation by inputting a determination manipulation or a manipulation command when the pointer is at the desired sound source.

The audio control apparatus may also move the pointer based on information other than the orientation of the head, e.g., hand gestures, and/or the like.

In this case, the orientation of the coordinate system of the virtual space need not necessarily be fixed to the actual space. Accordingly, the coordinate system of the virtual space may be fixed to the coordinate system of the headset. In other words, the virtual space may be fixed to the headset.

A description is provided below with respect to a case where the virtual space is fixed to the headset.

In this case, there is no need for the pointer position. computation section to generate headset tilt information. There is also no need for the audio synthesis section to use headset tilt information to localize the respective sound images of the sound sources.

The pointer position computation section restricts the movement range of the manipulation pointer to the sound source positions in the virtual space, and moves the manipulation pointer among the sound sources in accordance with manipulation information. In so doing, the pointer position computation section may compute a position relative to the initial position of the hand by integrating the acceleration, and determine the position of the manipulation pointer based on this relative position. However, since it is possible that a relative position computed thus might include a lot of errors, it is preferable that the ensuing pointer judging section be given a wide matching margin between the manipulation pointer position and the sound source position.

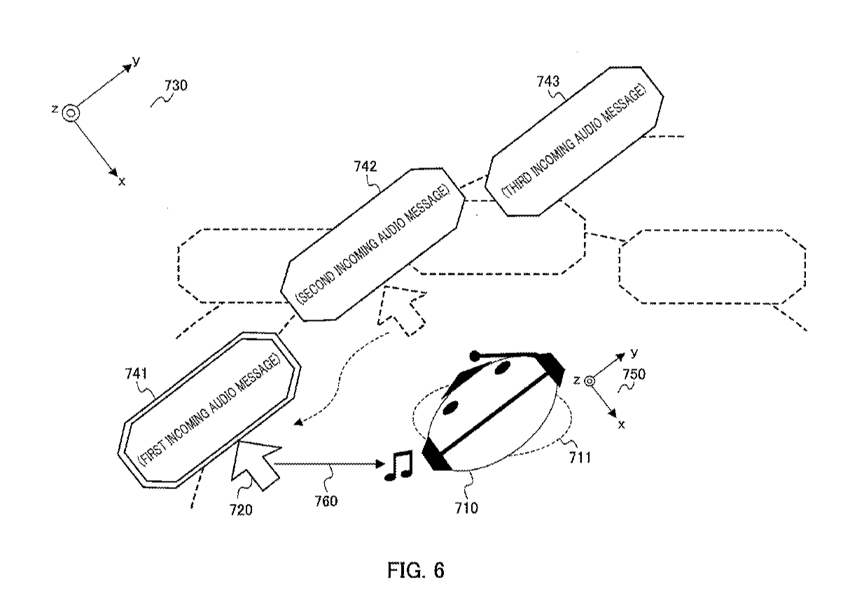

FIG. 6 is a schematic diagram showing a sound field feel example that synthesized audio data gives to the user when the virtual space is fixed to the headset, and is one that compares with FIG. 3.

As shown in FIG. 6, coordinate system 730 of the virtual space is fixed to headset coordinate system 750 irrespective of the orientation of the head of user 710. Accordingly, user 710 experiences a sound field feel where it is as if the positions of sound sources 741 through 743 allocated to the first through third incoming audio messages are fixed relative to the head. By way of example, the second incoming audio message would always be heard from straight ahead of user 710.

By way of example, based on acceleration information outputted from a 3D motion sensor worn on the hand of user 710, pointer position computation section 664 detects the direction in which the hand has been waved. Pointer position computation section 664 moves manipulation pointer 720 to the next sound source in the direction in which the hand was waved. Acoustic pointer generation section 667 disposes acoustic pointer 760 in the direction of manipulation pointer 720. Accordingly, user 710 experiences a sound field feel as if acoustic pointer 760 is heard from the direction of manipulation pointer 720.

If the pointer is to be moved based on information other than the orientation of the head, it may be the terminal apparatus itself, which includes the audio control apparatus, that is equipped with a 3D motion sensor for such a manipulation. In this case, an image of the actual space may be displayed on an image display section of the terminal apparatus, and the virtual space in which sound sources are disposed may be superimposed thereonto.

The manipulation input section may accept a provisional determination manipulation with respect to the current position of the pointer, and the acoustic pointer may be output as feedback in response to the provisional determination manipulation. The term “provisional determination manipulation” as used above refers to a manipulation that precedes by one step a determination manipulation with respect to the currently selected sound source. Various processes specifying the above-mentioned sound source are not executed at this provisional determination manipulation stage. In this case, through the feedback in response to the provisional determination manipulation, the user makes sure that the desired sound source is selected, and thereafter performs a final determination manipulation.

In other words, the acoustic pointer need not be outputted continuously as the pointer is moved, and may instead be outputted only after a provisional determination manipulation has been performed. Thus, the outputting of the acoustic pointer may be kept to a minimum, thereby making it easier to hear the incoming audio message.

Sound source positions may be mobile within the virtual space. In this case, the audio control apparatus determines the relationship between the positions of the sound sources and the position of the pointer based on the most up-to-date sound source positions by performing repeated updates every time a sound source is moved or at short intervals.

As described above, an audio control apparatus according to the present embodiment includes an audio control apparatus that performs a process with respect to sound sources disposed three-dimensionally in a virtual space, the audio control apparatus including; a pointer position computation section that determines the current position of a pointer, which is a selected position in the virtual space; and an acoustic pointer generation section that generates an acoustic pointer which indicates the current position of the pointer by means of a difference in acoustic state relative to its surroundings. It further includes: a sound source arrangement computation section that disposes the sound sources three-dimensionally in the virtual space; an audio synthesis section that generates audio that is obtained by synthesizing audio of the sound source and the acoustic pointer; a manipulation input section that accepts a determination manipulation with respect to the current position of the pointer; a manipulation command control section that performs the process specifying the sound source when the sound source is located at a position targeted by the determination manipulation. Thus, with the present embodiment, it is possible to know which of the sound sources disposed three-dimensionally in the virtual space is currently selected without having to rely on sight.

The disclosure of the specification, drawings and abstract included in Japanese Patent Application No. 2011-050584 filed on Mar. 8, 2011, is incorporated herein by reference in its entirety.

### INDUSTRIAL APPLICABILITY

An audio control apparatus and audio control method according to the claimed invention are useful as an audio control apparatus and audio control method with which it is possible to know which of sound sources disposed three-dimensionally in a virtual space is currently selected without having to rely on sight. In other words, the claimed invention is useful for various devices having audio playing functionality, e.g., a mobile phone, a music player, and/or the like, and may be utilized for business purposes, continuously, and repeatedly in industries in which such devices are manufactured, sold, provided, and/or utilized.

### REFERENCE SIGNS LIST

100 Terminal apparatus

200 Communications network

300 Audio message management server

400 Audio input/output apparatus

500 Manipulation input apparatus

600 Audio control apparatus

610 Communications interface section

620 Audio input/output section

630 Manipulation input section

640 Storage section

650 Playback section

660 Control section

661 Sound source interrupt control section

662 Sound source arrangement computation section

663 Manipulation mode identification section

664 Pointer position computation section

665 Pointer judging section

666 Selected sound source recording section

667 Acoustic pointer generation section

668 Audio synthesis section

669 Manipulation command control section

1. An audio control apparatus that performs a process with respect to sound sources disposed three-dimensionally in a virtual space, the audio control apparatus comprising:
a pointer position computation section that determines a current position of a pointer, the current position being a selected position in the virtual space; and
an acoustic pointer generation section that generates an acoustic pointer, the acoustic pointer indicating the current position of the pointer by means of a difference in acoustic state relative to its surroundings.

2. The audio control apparatus according to claim 1, wherein the acoustic pointer comprises a predetermined sound outputted from the current position of the pointer.

3. The audio control apparatus according to claim 1, wherein the acoustic pointer comprises a difference between audio of the sound source, which corresponds to the current position of the pointer, and other audio.

4. The audio control apparatus according to claim 3, wherein the difference in audio comprises the audio of the sound source being clearer than the other audio.

5. The audio control apparatus according to claim 1, further comprising:
a sound source arrangement computation section that disposes the sound sources three-dimensionally in the virtual space;
an audio synthesis section that generates audio, the audio being obtained by synthesizing audio of the sound source with the acoustic pointer;
a manipulation input section that accepts a determination manipulation with respect to the current position of the pointer; and
a manipulation command control section that performs the process specifying the sound source when the sound source is located at a position targeted by the determination manipulation.

6. The audio control apparatus according to claim 5, wherein the manipulation input section further accepts a movement manipulation with respect to the pointer.

7. The audio control apparatus according to claim 5, wherein the virtual space comprises a space whose orientation is fixed to an actual space, wherein an initial state of the orientation of the head of a user listening to the audio of the sound source in the actual space is taken to be a reference.

8. The audio control apparatus according to claim 7, wherein the manipulation input section obtains, as a direction of the current position of the pointer, a direction currently squarely forward of the head of the user in the virtual space.

9. The audio control apparatus according to claim 5, wherein the current position comprises a current position and an immediately preceding position of the pointer.

10. The audio control apparatus according to claim 5, further comprising:
an audio input section that receives speech by the user; and
a communications interface section that sends audio data of the received speech to another apparatus, and that receives audio data sent from the other apparatus, wherein
the sound source arrangement computation section allocates the sound sources to respective senders of the received audio data, and
the audio synthesis section converts the received audio data into audio data from corresponding sound sources.

11. The audio control apparatus according to claim 5, wherein
the manipulation input section accepts a provisional determination manipulation with respect to the current position of the pointer, and
the acoustic pointer comprises feedback with respect to the provisional determination manipulation.

12. An audio control method that performs a process with respect to sound sources disposed three-dimensionally in a virtual space, the audio control method comprising:
determining a current position of a pointer, the current position being a selected position in the virtual space; and
generating an acoustic pointer, the acoustic pointer indicating the current position of the pointer by means of a difference in acoustic state relative to its surroundings.
